(19) United States
(12) Patent Application Publication
(10) Pub. No.: US 2021/0049993 A1
(43) Pub. Date: Feb. 18, 2021

(54) DOUBLE-ENCLOSURE ACOUSTIC ELEMENT OF SMALL SIZE, IN PARTICULAR FOR AN AIRCRAFT ACOUSTIC PANEL

(71) Applicant: Airbus Operations (S.A.S.), Toulouse (FR)

(72) Inventors: Laurent Cazeaux, Toulouse (FR); Florent Mercat, Toulouse (FR); Claire Maffre, Toulouse (FR)

(21) Appl. No.: 16/987,949

(22) Filed: Aug. 7, 2020

(30) Foreign Application Priority Data
Aug. 13, 2019 (FR) 1909189

(51) Int. Cl. G10K 11/162; B64D 33/00

(52) U.S. Cl. CPC G10K 11/162; B64D 2033/0206; B64D 33/00

(57) ABSTRACT

A double-enclosure acoustic element of small size, in particular for an aircraft acoustic panel. The acoustic element has a first enclosure with a mouth and a second enclosure with, at a front longitudinal end, a mouth and arranged inside the first enclosure, these first and second enclosures being joined together at the front. The acoustic element includes a slotting assembly system, the assembly system including at least one protruding element on the first edge of one of the first and second enclosures and at least one recess in the first edge of the other of the first and second enclosures, the protruding element and the recess having complementary shapes such that the protruding element can be slotted into the recess. Thus, the two enclosures can be assembled by quick and easy slotting.

### CROSS-REFERENCE TO RELATED APPLICATION

This application claims the benefit of and priority to French patent application number 19 09189 filed on Aug. 13, 2019, the entire disclosure of which is incorporated by reference herein.

### TECHNICAL FIELD

The disclosure herein relates to a double-enclosure acoustic element of small size, and to an acoustic attenuation panel for an aircraft, in particular for a propulsion assembly, provided with such acoustic elements.

### BACKGROUND

It is known that, on an aircraft, for example on a transport airplane, significant noise is often generated, in particular by the propulsion assemblies of the aircraft. It is known practice, in order to reduce the acoustic effect produced by the propulsion assemblies, to provide, in particular in the region of the nacelles of the propulsion assemblies, walls provided with panels exhibiting good sound absorption. Conventionally, an acoustic attenuation panel comprises generally a plate made of a material and/or a structure exhibiting good sound absorption properties, in particular for the most disturbing noise frequencies.

This plate often has a cellular honeycomb structure and is provided on its two faces with a skin referred to as resistive skin, which is often perforated, and a rear skin that is not perforated, respectively. The acoustic panel is designed such that the resistive skin is situated close to the source of noise, in particular upstream and/or downstream of the fan in the case of an aircraft engine, so as to effectively absorb the noise generated upstream and downstream of the fan.

The size of the cells (area and height) of the honeycomb structure is generally adapted to the frequency of the noise to be absorbed. However, if the noise varies, in particular if the frequency of the noise to be absorbed drops (from 300 Hz to about 700 Hz), for example because of a reduction in the rotational speed of the fan linked with an increase in the diameter thereof, it is necessary to increase the height of the cells, causing an increase in the thickness of the cellular structure. This increase in the size of the honeycomb structure brings about drawbacks in terms of weight, size and induced drag.

A sound absorbing structure for absorbing low frequency sound waves is described in the document “Aero-acoustic liner applications of the broadband special acoustic absorber concept, American Institute of Aeronautics and Astronautics, AIAA 2013-2176, 19th AIAA/CEAS Aeroacoustics Conference May 27-29, 2013, Berlin, Germany”. That structure comprises a plurality of capsules closed by a skin in contact with the medium through which the sound waves propagate such that each one delimits a cavity in which a hollow cone is positioned, at a distance from the capsule, which has a base opening out at the skin. Each cone comprises at least one acoustic orifice, making it possible to cause the interior of the cone to communicate with the space between the cone and the capsule, the orifice being positioned and dimensioned as per the desired acoustic characteristics. In addition, the skin is porous at least in line with each cone. A sound absorbing structure formed in this way and based on the same principle as a Helmholtz resonator and a quarter-wave resonator, makes it possible to attenuate low-frequency sound.

This advantageous technology, based on a plurality of acoustic elements (having a capsule and cone), has a certain bulk, however, which may become large for certain applications using a large number of such acoustic elements.

The disclosure herein deals with the manner of assembling the cones and capsules in order to simplify integration in the sound absorbing structure.

### SUMMARY

The disclosure herein has an object of making it easier to assemble an acoustic element while maintaining the acoustic performance thereof. To this end, it relates to an acoustic element comprising:
a first enclosure provided with a first mouth surrounded by a first edge at a longitudinal end referred to as front longitudinal end; and
a second enclosure likewise provided, at a front longitudinal end, with a first mouth surrounded by a first edge, the second enclosure being arranged inside the first enclosure, the first and second enclosures being joined together at their first edges.

According to the disclosure herein, the acoustic element comprises a slotting assembly system, the assembly system comprising at least one protruding element arranged on the first edge of one of the first and second enclosures and at least one recess made in the first edge of the other of the first and second enclosures, the protruding element and the recess having complementary shapes such that the protruding element can be slotted into the recess.

Thus, the two enclosures can be assembled by quick and easy slotting.

In this preferred embodiment, the two following realizations are possible:
the protruding element(s) is/are arranged on the first edge of the second enclosure and the recess(es) is/are made in the first edge of the first enclosure; or
the protruding element(s) is/are arranged on the first edge of the first enclosure and the recess(es) is/are made in the first edge of the second enclosure.

In one particular embodiment, the assembly system comprises a plurality of protruding element and cooperating recess pairs, and, for each of the pairs, the protruding element and the recess have complementary shapes.

Moreover, in a preferred embodiment, the protruding element is a ring and the recess is an annular groove.

Furthermore, advantageously, the second enclosure is provided with an external lip at the first edge, the lip being provided with a contact face that comes into contact with a front face of the first edge of the first enclosure when the first and second enclosures are assembled.

The disclosure herein also relates to an acoustic panel for an aircraft, the acoustic panel comprising a plate made of a sound absorbing material and a skin referred to as resistive skin and a skin referred to as rear skin, which are arranged, respectively, on either side of this plate.

According to the disclosure herein, the plate is provided with a plurality of through-housings made in the sound absorbing material of the plate, and the acoustic panel has a plurality of acoustic elements like the one described above, each of the acoustic elements being fixed in one of the housings.

Moreover, the disclosure herein relates to a propulsion assembly for an aircraft, having at least one acoustic element and/or at least one acoustic panel, like the ones described above.

The disclosure herein also relates to an aircraft having at least one acoustic element and/or at least one acoustic panel and/or at least one propulsion assembly, like those mentioned above.

### BRIEF DESCRIPTION OF THE FIGURES

The appended figures will make it easy to understand how the disclosure herein can be implemented. In these figures, identical references denote similar elements.

FIG. 1 is a schematic view in cross section of an acoustic element mounted in an acoustic panel.

FIG. 2 is a schematic view revealing geometric characteristics of an acoustic element.

FIG. 3 is a schematic view, in perspective, of a first particular embodiment of an acoustic element.

FIG. 4 is a schematic view, in perspective, of an external, capsule-type enclosure of the acoustic element in FIG. 3.

FIG. 5 is a schematic view, in perspective, of an internal, cone-type enclosure of the acoustic element in FIG. 3.

FIG. 6 is a view, in perspective, of the acoustic element in FIG. 3 cut in half longitudinally.

FIG. 7 is a schematic view, in perspective, of a second particular embodiment of an acoustic element.

FIG. 8 is a schematic view, in perspective, of an internal, cone-type enclosure of the acoustic element in FIG. 7.

FIG. 9 is a view, in perspective, of the acoustic element in FIG. 7 cut in half longitudinally.

FIG. 10 is a view, in perspective, of a third particular embodiment of an acoustic element cut in half longitudinally.

FIG. 11 is a schematic view, in perspective, of an internal, cone-type enclosure of the acoustic element in FIG. 10.

FIG. 12 is a view, in perspective, of an acoustic element cut in half longitudinally, provided with an assembly system in accordance with a first embodiment,

FIG. 13 shows, in an enlarged view, a part of the view in FIG. 12 relating to the assembly system.

FIG. 14 is a view, in perspective, of an acoustic element cut in half longitudinally, provided with an assembly system in accordance with a second embodiment.

FIG. 15 shows, in an enlarged view, a part of the view in FIG. 14 relating to the assembly system.

FIG. 16 shows a step of assembling the two enclosures of the acoustic element, which are shown cut in half longitudinally and in perspective.

FIG. 17 schematically illustrates the main steps in a method for manufacturing an acoustic element provided with an assembly system.

FIG. 18 is a side view of an aircraft, to which the disclosure herein can be applied.

FIG. 19 is a perspective view of a part of a propulsion assembly of the aircraft in FIG. 18, which has an acoustic panel.

### DETAILED DESCRIPTION

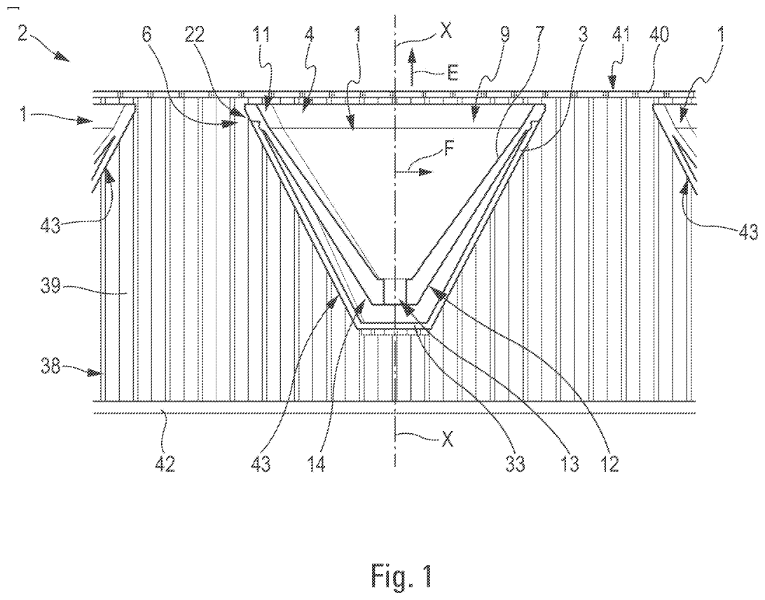

The acoustic element 1 shown schematically in one particular embodiment in FIGS. 1 and 3 is intended to make it possible to reduce (or attenuate) noise by absorbing it, in particular on an aircraft.

In one preferred application set out below with reference to FIG. 1, a plurality of such acoustic elements 1 are integrated in an acoustic panel 2 (or acoustic attenuation panel) intended to make it possible to reduce noise, for example on a nacelle or another part of a propulsion assembly of an aircraft.

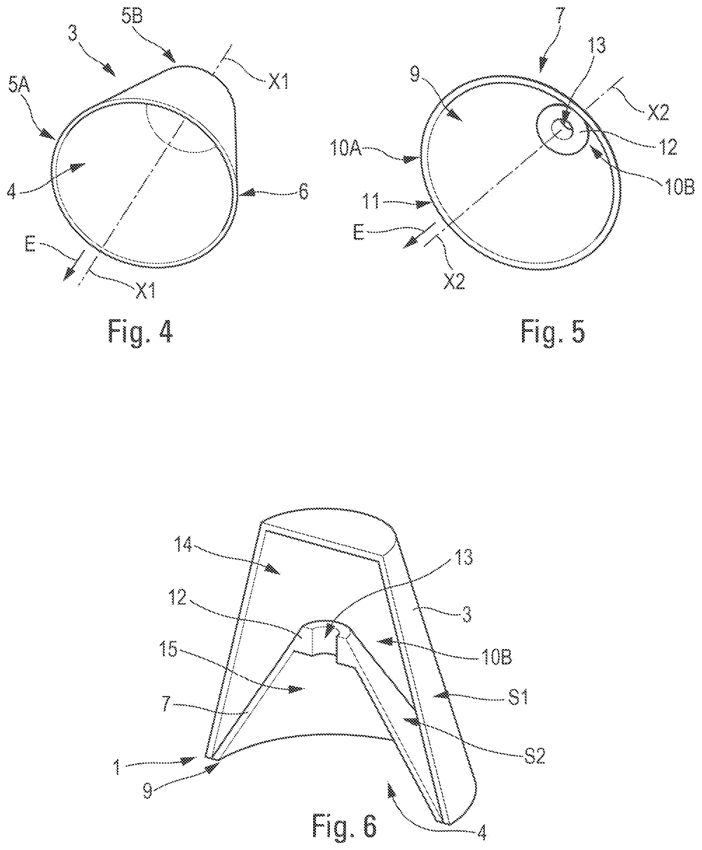

The acoustic element 1 comprises, as shown in particular in FIGS. 1 through 3:
an elongate external enclosure 3, referred to as capsule, of longitudinal axis X1-X1 (FIG. 4), and of frustoconical shape. This enclosure 3 is provided with a mouth 4 at a front longitudinal end 5A, as shown in FIG. 4. This mouth 4 is surrounded and delimited by an edge 6; and
an elongate internal enclosure 7, referred to as cone, of longitudinal axis X2-X2 (FIG. 5), and likewise of frustoconical shape. This enclosure 7 is provided with a mouth 9 at a front longitudinal end 10A, as shown in FIG. 5. This mouth 9 is surrounded and delimited by an edge 11.

The enclosure 7 is arranged inside the enclosure 3, as shown in FIGS. 1 to 3, such that the longitudinal axes X1-X1 and X2-X2 are coincident with a longitudinal axis X-X of the acoustic element 1, and the enclosures 3 and 7 are joined together at their front edges 6 and 11.

In FIGS. 1 and 3, the longitudinal axis X-X of the acoustic element 1 is shown. In addition, an arrow E indicates a direction defining what is referred to as a direction towards the “front” (directed along the longitudinal axis X-X and towards a source of noise to be processed) with respect to the acoustic element 1 and/or to the enclosures 3 and 7. The opposite direction to that of the arrow E defines what is referred to as a direction towards the “rear” with respect to the acoustic element 1 and/or to the enclosures 3 and 7. In the rest of the description, the adjectives “rear” and “front” are defined with respect to the direction of the arrow E.

Furthermore, adjectives “internal” and “external” are also defined with reference to the longitudinal axis X-X (or to the longitudinal axes X1-X1 and X2-X2 as the case may be), and with respect to the direction of an arrow F (FIGS. 1 and 3) that is directed radially away from the longitudinal axis X-X. The adjective “external” is defined in the direction of the arrow F, that is to say away from the longitudinal axis X-X (or X1-X1 or X2-X2), and the adjective “internal” is defined in the opposite direction to that of the arrow F, that is to say towards the longitudinal axis X-X (or X1-X1 or X2-X2).

According to the disclosure herein, the enclosure 7 comprises, at the rear longitudinal end 10B away from the front end 10A provided with the mouth 9, an elongate part 12 provided with at least one opening 13 which, as shown in FIGS. 1, 2, 3 and 6 in particular, has a cylindrical shape (that is to say with a longitudinally constant cross section). This opening 13 passes through the elongate part 12 along the longitudinal axis X-X.

A space referred to as intermediate space 14 having a volume V is created between the enclosures 3 and 7, and the opening(s) in the elongate part 12, which pass right through the latter, make it possible to create a path of communication (in particular for sound) between an internal space 15 of the enclosure 7 and the intermediate space 14, in order to absorb sound in the intermediate space 14.

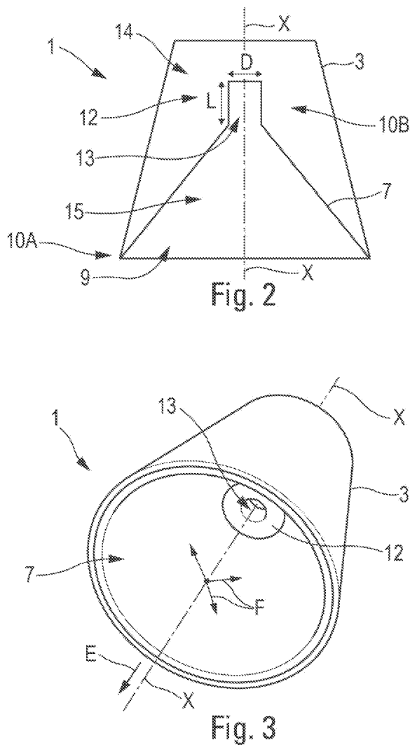

The elongate part 12 has an at least partially cylindrical external shape. The elongate part 12 is arranged in the continuation of the enclosure 7 towards the rear, along the axis X2-X2. As shown in FIG. 2, the elongate part 12 has a length L along the axis X-X (or the axis X2-X2).

The elongate part 12 is provided with a free end away from the front longitudinal end 10A. In one particular embodiment, the elongate part 12 has a cylindrical shape at this free end. In another embodiment, the elongate part 12 has an entirely cylindrical shape.

This elongate part 12 having at least one cylindrical opening 13 creates an acoustic effect of the Helmholtz resonator type for filtering low frequencies, More specifically, this elongate part 12 opening onto the intermediate space 14 forms a Helmholtz resonator, in which the elongate part 12 represents the neck and the intermediate volume 14 represents the volume of the resonator. High frequencies are attenuated by the quarter-wave resonator formed by a resistive skin 40 and the second enclosure 7.

The acoustic performance P of the acoustic element 1 depends in particular on the product of the volume V of the intermediate space 14 and the length L of the elongate part 12 (P=L·V).

For a conventional acoustic element that does not have such an elongate part 12, the length L is defined by the thickness of the rear wall of the enclosure 7, which has a small thickness, for example around 1 mm.

The product L·V defines a given performance level, Consequently, in order to maintain a given acoustic performance, by increasing the length L (by virtue of the elongate part 12), it is possible to reduce the volume V of the intermediate space 14 and thus provide a smaller volume and thus a small size of the acoustic element 1.

By way of illustration:
the length L may be between 2 mm and 15 mm; and
the diameter D may be between 0.8 mm and 5 mm.

In such an example, with the length being multiplied by a factor of between 2 and 15 (on changing from a conventional acoustic element with a thickness of 1 mm to the acoustic element 1 provided with an elongate part 12 with a length of between 2 mm and 15 mm), a reduction in the volume V of the intermediate space 14 between the enclosures 3 and 7 by a similar factor can be envisaged for the acoustic element 1 compared with the conventional acoustic element, with a similar acoustic performance being maintained. This reduction in the intermediate space 14 makes it possible to use an external enclosure 3 having a smaller size, the size of this enclosure 3 defining the size of the acoustic element 1 as a whole.

The length L is chosen depending on the sound frequency intended to be absorbed and on integration constraints. A large volume V of the intermediate space 14 makes it possible to absorb sounds exhibiting low frequencies.

From another point of view, since the acoustic performance depends on the abovementioned product L·V, with a constant volume V and thus a constant size, the provision of the elongate part 12 (and thus the increase in length L) brings about an improvement in the acoustic performance.

In a first embodiment, shown in FIGS. 3 through 6, the elongate part 12 is provided with a single, central cylindrical opening 13. This central opening 13 is coaxial with the axis X2-X2 (FIG. 5). This opening 13 has a diameter D (FIG. 2).

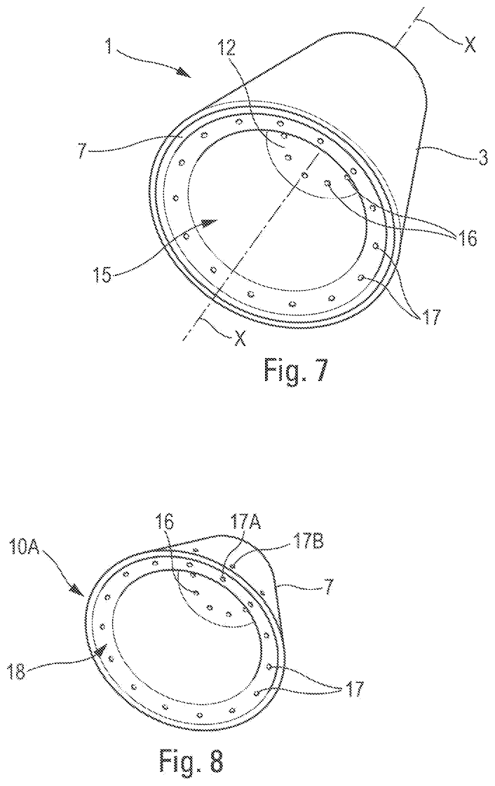

Moreover, in a second embodiment shown in FIGS. 7 through 9, the elongate part 12 is provided with a plurality of openings 16 having a cylindrical shape (that is to say with a longitudinally constant cross section), which are made in the elongate part 12 and distributed in a manner arranged in a circle. Of course, any other distribution of the openings 16 in the elongate part 12 is conceivable. Each of the openings 16 passes through the elongate part 12 along an axis parallel to the longitudinal axis X-X.

For one and the same length of the elongate part 12, a similar acoustic performance (for absorption of identical sound frequencies) is obtained between the first and second embodiments, if the sum of the areas of the cross sections of the openings is more or less the same, that is to say if the sum of the areas of the circular cross sections of all of the openings 16 (in the second embodiment) is more or less the same as the area of the circular cross section of the single opening 13 (in the first embodiment).

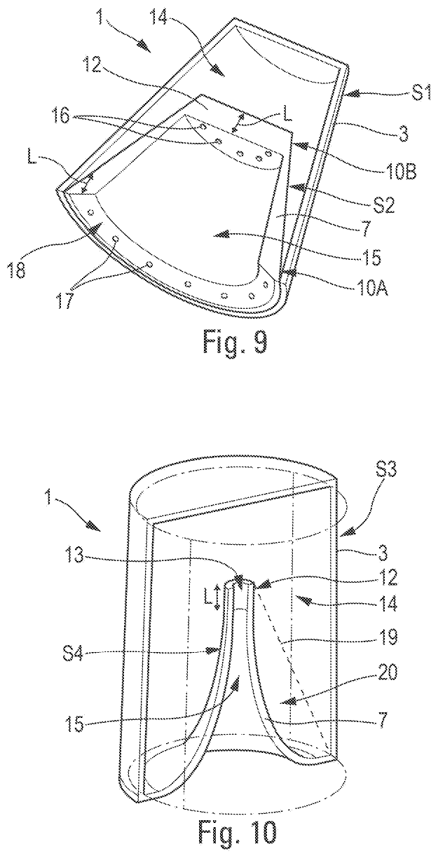

Furthermore, in this second embodiment, the enclosure 7 has cylindrical perforations 17 (that is to say perforations with a longitudinally constant cross section) that are made from a front face 18 (at the front end 10A) and pass through the conical wall of the enclosure 7, as can be seen in FIG. 8. The cylindrical perforations 17 are distributed in a manner arranged in a circle. FIG. 8 shows a front end 17A of any perforation 17 and the corresponding rear end 17B thereof. The front end 18 is bevelled, as can be seen in FIG. 9.

Although shown only in this second embodiment, perforations such as these perforations 17 can also be provided in the other embodiments described.

In addition to allowing normal operation of the double-enclosure acoustic element 1 the openings 16 and the perforations 17 also make it possible to generate an acoustic effect of the Helmholtz resonator type and, if necessary, to effect drainage of liquid (and the evacuation thereof from the internal space 16 to the intermediate space 14).

In one particular embodiment, the openings 16 and the perforations 17 have more or less one and the same length and one and the same diameter.

In the scope of the disclosure herein, the enclosures 3 and 7 can have various shapes.

In the first and second embodiments mentioned above, the enclosures 3 and 7 each have a frustoconical shape S1, S2, as shown in FIGS. 6 and 9. Other shapes are possible, for example a pyramid shape.

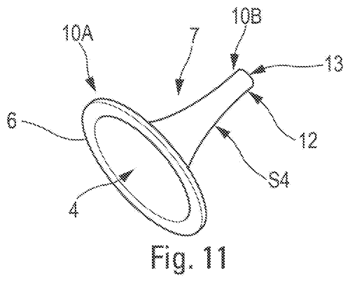

In a third embodiment (shown in FIGS. 10 and 11), the enclosure 3 has a cylindrical shape S3 and the enclosure 7 has a flared shape with a concave wall. As shown in FIG. 10, the flared shape with a concave wall of the enclosure 7 is that of a hyperbolic funnel S4. By way of example, this shape is that of a trumpet. It can also have a frustoconical shape with concave walls, a cone ending in a narrow tube, etc.

The elongate part 12 of length L is also provided at the rear end 10B of the enclosure 7. This elongate part 12 is provided with a single, central cylindrical opening 13. This central cylindrical opening 13 is coaxial with the longitudinal axis of the hyperbolic funnel shape S4.

This hyperbolic funnel shape S4 is less radially extensive (with respect to the longitudinal axis) than a frustoconical shape, as shown in FIG. 10 by a dashed line 19 illustrating the edge of a frustoconical shape. This shape S4 makes it possible to free up additional space identified by a reference 20 between the external wall of the enclosure 7 and the line 19, thereby making it possible to increase the volume of the intermediate space 14 (intended for sound absorption) for one and the same external enclosure 3.

A main advantage of this third embodiment is that, in order to maintain one and the same volume of the intermediate space 14, it is possible to provide a smaller enclosure 3. In particular, the diameter of the enclosure 3 can be smaller. Thus, this third embodiment makes it possible to reduce the size of the acoustic element 1 compared with the first and second embodiments described above.

Furthermore, in a preferred embodiment, the acoustic element 1 has a slotting assembly system 22, which is configured to join the enclosures 3 and 7 together at their edges 6 and 11 as shown in FIGS. 1 and 12 through 15.

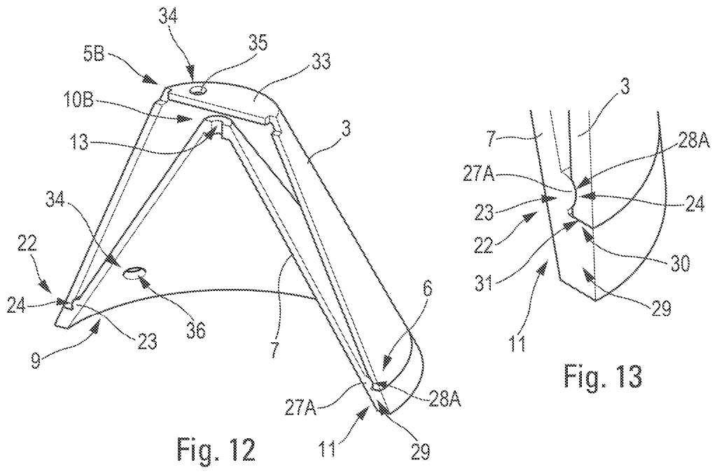

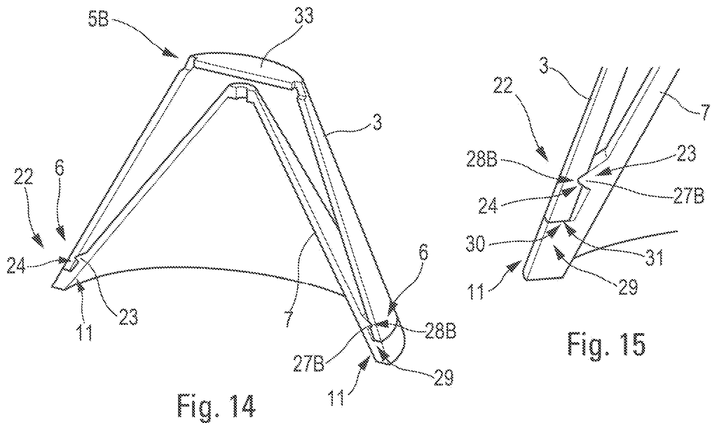

This slotting assembly system 22 can be applied to each of the embodiments described above. The assembly system 22 comprises at least one protruding element 23 arranged on the front edge of one of the enclosures 3 and 7 and at least one recess 24 made in the front edge of the other of the enclosures 3 and 7. The protruding element 23 and the recess 24 have complementary shapes such that the protruding element 23 can be slotted into the recess 24, in an assembled position (of the enclosures 3 and 7) as shown in FIGS. 12 and 14 in particular.

In a preferred embodiment, the assembly system 22 comprises a protruding element 23 arranged on an external face of the edge 11 of the enclosure 7 and a recess 24 made in an internal face of the edge 6 of the enclosure 3.

In a variant (not shown), the assembly system 22 may also comprise at least one protruding element arranged on the edge 6 of the enclosure 3 and at least one recess made in the edge 11 of the enclosure 7.

Thus, the two enclosures 3 and 7 of the acoustic element 1 (of the capsule type and cone type, respectively) can be assembled together by simple slotting with the aid of the assembly system 22. This slotting assembly can be effected easily and especially quickly, as set out below.

In one variant (not shown), the assembly system may comprise a plurality of pairs (each of which is formed by a protruding element and a cooperating recess), and, for each of the pairs, the protruding element and the recess have complementary shapes. In this case, preferably, the assembly system has protruding elements on only a part of the circumference of the enclosure in question, and in particular of the internal enclosure 7.

In the preferred embodiment shown in FIGS. 12 through 15, the protruding element 23 is a ring 27A, 27B that extends around the entire external periphery of the internal enclosure 7 at its front edge 11, and the recess 24 is an annular groove 28A, 28B formed around the entire internal periphery of the external enclosure 3 at its front edge 6.

In a first realization of this preferred embodiment, shown in FIGS. 12 and 13, the ring 27A and the groove 28A, which have complementary shapes, have a semicircular cross section.

Moreover, in a second realization of this preferred embodiment, shown in FIGS. 14 and 15, the ring 27B and the groove 28B, which have complementary shapes, have a triangular cross section.

Of course, in the scope of the disclosure herein, other cross sections are possible for the complementary shapes of the protruding element 23 and of the recess 24.

Furthermore, as shown in FIGS. 12 through 15, the enclosure 7 is provided with an external lip 29 at the front edge 11. This lip 29 is provided with a contact face 30 that comes into contact with a front face 31 of the edge 6 of the enclosure 3.

Moreover, the enclosure 3 is provided with a closed end wall 33, at the rear longitudinal end 5B, as shown in FIGS. 12 and 14 in particular,

Moreover, in an embodiment variant (not shown), the enclosure 3 can be open at the rear longitudinal end 5B (that is to say not have an end wall). In this case, provision can be made for this opening to be closed by an end wall formed by a part of the structure in which the acoustic element 1 is arranged, for example a part of the acoustic panel 2 in FIG. 1.

Furthermore, in one particular embodiment, the acoustic element 1 has a drainage system 34 (FIG. 12). This drainage system 34, which is intended to reduce a potential volume of fluids liable to stagnate in the acoustic element 1 (thereby limiting the risks of damage to the acoustic element 1 and impairment of the proper operation thereof in terms of acoustic treatment), can be of different conventional types. By way of (non-limiting) illustration, the drainage system 34 has at least one hole 35 (or perforation) made in the enclosure 3 and at least one hole 36 (or perforation) made in the enclosure 7, as shown in FIG. 12, for evacuating, if necessary, a fluid that has been able to pass into the acoustic element 1 out of the latter.

The drainage system 34 may also have perforations such as the perforations 17 in FIG. 8.

In the scope of the disclosure herein, the enclosures 3 and 7 (and thus the acoustic element 1) can be made from different materials.

Preferably, the enclosures 3 and 7 are made:
from a thermoplastic material (injection-moulded or moulded); or
from a metal, such as stainless steel, aluminum or titanium, or from a metal alloy such as Inconel.

The acoustic element 1, as described above, has numerous advantages; and in particular:
it can be produced so as to have a small size for a similar performance compared with a conventional acoustic element (which does not have an elongate part) or so as to have a better performance with a capacity to absorb lower sound frequencies for a similar size compared with a conventional acoustic element. It is also possible to combine both advantages, admittedly with lower proportions, namely produce the acoustic element such that it exhibits both an improvement in acoustic performance and a reduction in size compared with a conventional acoustic element;
it can be produced with any type of material;
it can be produced with various geometric shapes of the enclosures (capsule and cone);
it can have all the conventional drainage systems; and
it makes it possible to add indexing means between the enclosures.

In addition, for the embodiment (in FIGS. 12 through 15) comprising the slotting assembly system 22, the acoustic element 1 also has the following advantages:
quick assembly of the enclosures 3 and 7 (capsule and cone), by virtue of the (quick) slotting assembly system 22, resulting in a time saving;
quick and easy assembly of the enclosures 3 and 7 (cone and capsule), by virtue of the slotting assembly system 22, in particular with the possibility of eliminating an adhesive bonding operation and thus the use of adhesive; and
it can have one or more protruding elements 23 on only a part of the circumference of one of the enclosures, in particular of the internal enclosure 7 (cone).

A method P for manufacturing an acoustic element 1 provided with a slotting assembly system 22, as shown in FIGS. 12 through 15, will be described below.

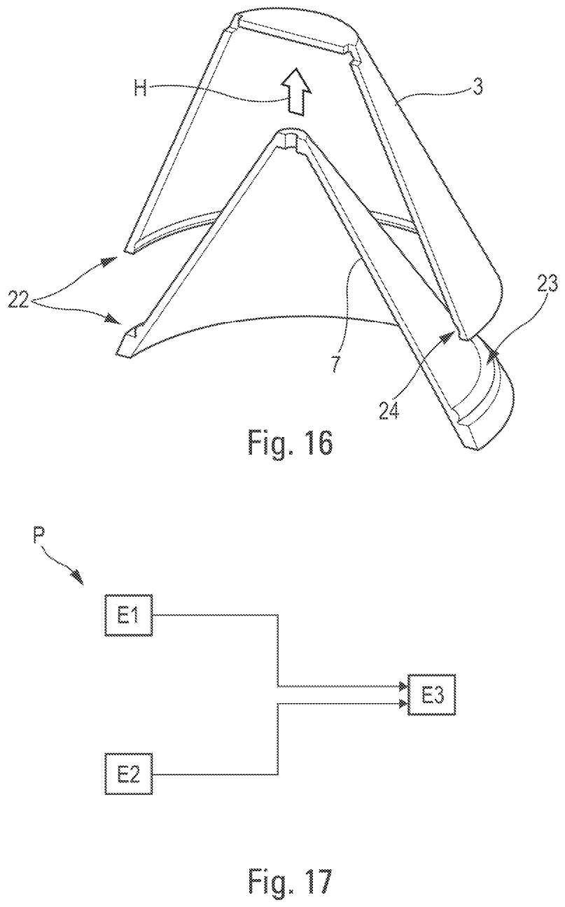

This manufacturing method P includes a plurality of steps comprising at least the following steps, as illustrated in FIG. 17:
a manufacturing step E1 consisting in or comprising manufacturing the enclosure 3;
a manufacturing step E2 consisting in or comprising manufacturing the enclosure 7; and
an assembly (or mounting) step E3 consisting in or comprising introducing the enclosure 7 (cone) into the enclosure 3 (capsule), as illustrated by an arrow H in FIG. 16. This introduction is carried out until the enclosures 3 and 7 (manufactured in manufacturing steps E1 and E2) are joined together, by slotting the protruding element 23 into the recess 24, so as to obtain the assembled acoustic element 1 in FIG. 12.

The manufacturing steps E1 and E2 can be implemented successively (in any order) or at the same time (that is to say in parallel).

The manufacturing steps E1 and E2 can be implemented in different ways, in particular depending on the material used to manufacture the enclosures 3 and 7.

When the enclosures 3 and 7 are made of thermoplastic material, the manufacturing steps E1 and E2 can use a method involving injection-moulding thermoplastic resin (loaded or not loaded with fibers). The manufacturing steps E1 and E2 can also make use of a moulded thermoplastic.

For the injection-moulding method, in order to simplify and retain a mould identical to the one used for existing enclosures (capsule and cone), it is possible to take into account the flexibility of the element or to change the temperature of the mould at the time of ejection (malleability of the material).

When the enclosures 3 and 7 are made of metal, the manufacturing steps E1 and E2 can use a stamping method or a rolling method. For metal enclosures 3 and 7, novel methods can also be envisaged, such as the use of electromagnetic pulses.

The acoustic element 1, as described above, can be used in numerous applications.

In a preferred application, a plurality of such acoustic elements 1 are arranged in an acoustic panel 2 (or acoustic attenuation panel), as shown schematically in FIG. 1.

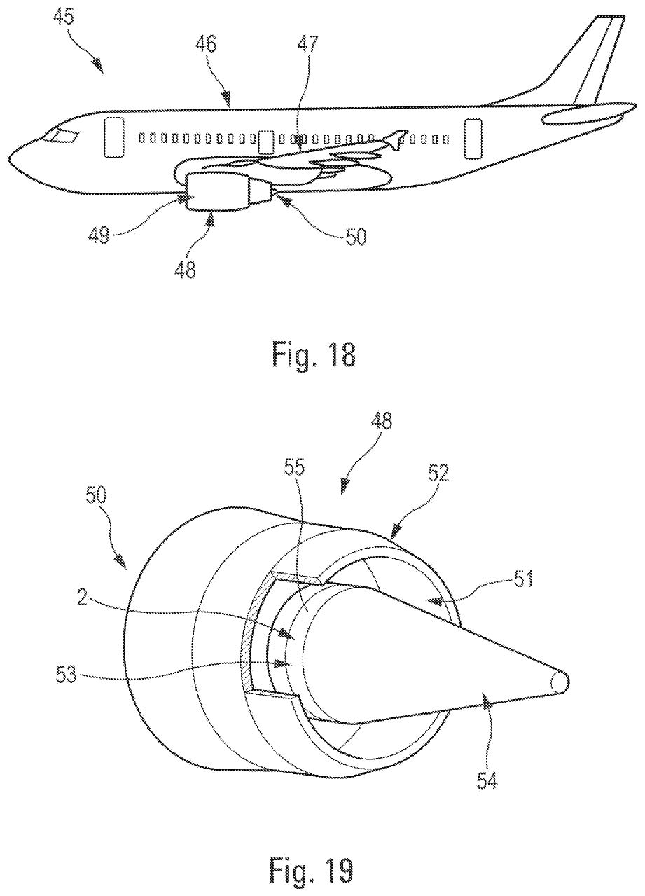

This acoustic panel 2 is intended to make it possible to reduce (or attenuate) noise by absorbing it, on an aircraft 45 (FIG. 18), in particular on a transport airplane.

In a conventional manner, this acoustic panel 2 comprises, as shown in FIG. 1:
a plate 38 made of a sound absorbing material 39, for example foam or honeycomb, that is to say a material that is able to absorb noise in order to attenuate it;
a skin 40 referred to as resistive skin, which is permeable to sound, that is to say for example provided with a plurality of perforations (or holes, clearances, cutouts) 41 passing right through the resistive skin 40; and
a skin 42 referred to as rear skin (or “backing skin”) for closing the acoustic panel 2 and ensuring structural rigidity. This rear skin 42 is not perforated and has a degree of impermeability to sound.

Generally, the acoustic panel 2 is disposed such that the resistive skin 40 is positioned in the vicinity of and preferably close to (or next to) the source of noise to be attenuated. The noise penetrates through the perforations 41, through the resistive skin 40, into the interior of the plate 38, where it is attenuated.

The plate 38 of the acoustic panel 2 is provided with a plurality of housings 43 that are made in the sound absorbing material 39 of the plate 38.

In addition, the acoustic panel 2 has a plurality of acoustic elements 1 like those described above, which are able to absorb sound. Each of the acoustic elements 1 is arranged in one of the housings 43 made in the plate 38, with the mouths 4 and 9 next to the resistive skin 40.

Thus, the acoustic elements 1 are integrated in the plate 38 made of sound absorbing material 39 of the acoustic panel 2, thereby making it possible to absorb noise with different frequencies, and in particular lower frequencies, than those of the noise absorbed by the material 39 of the plate 38. The combination of the acoustic plate 38 and the acoustic elements 1 thus makes it possible to increase the range of frequencies of noise able to be attenuated by the acoustic panel 2.

In the scope of the disclosure herein, the plate 38 and the acoustic elements 1 can be made from the same material or from different materials. The material of the plate 38 and/or of the acoustic elements 1 can be, for example, a polymer material reinforced with carbon fibers of the CFRP (carbon fiber reinforced polymer) type, aramid fibers, glass fibers, or metal such as aluminum or titanium.

Various possible examples of the integration of acoustic elements 1 in an acoustic panel 2 will be presented below.

By way of illustration, on an aircraft propulsion assembly:
if the acoustic elements 1 are made of a thermoplastic composite material, they can be integrated in a foam or honeycomb structure, for application to acoustic panels of the external structure;
if the acoustic elements 1 are made of aluminum, they can be integrated in an aluminum honeycomb, for application to acoustic panels of the IFS (internal fixed structure) fairing surrounding the motor of a jet engine; and
if the acoustic elements 1 are made of a metal alloy (such as Inconel) or of titanium, for application to exhaust elements such as nozzles or plug-type parts, they can be integrated directly in the skins of these exhaust elements or integrated in a honeycomb.

A preferred application also relates to a propulsion assembly 48 of an aircraft 45. FIG. 18 shows an aircraft 45, which has a fuselage 46, two wings 47 disposed on either side of the fuselage 46, and propulsion assemblies 48 fixed under the wings 47. Each propulsion assembly 48 comprises a nacelle 49 and a turbomachine 50 positioned inside the nacelle 49. In an embodiment shown in FIG. 19, the turbomachine 50 comprises, at the rear, a primary exhaust duct 51 via which the gases burnt by the turbomachine 50 escape and which is delimited on the outside by a primary nozzle 52 and on the inside by an internal structure 53 extended by a nozzle cone 54.

In one configuration, the internal structure 53 comprises an acoustic panel 2, positioned on a skin 55, which delimits the primary exhaust duct 51. Of course, the acoustic panel can be positioned on any skin that has an outer surface in contact with a medium in which sound waves propagate, for example a lip and an air inlet duct of the nacelle 49, a fan casing of the nacelle 49 or any other surface of the propulsion assembly 48.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s), In addition, in this disclosure, the terms “comprise” or “comprising” do not exclude other elements or steps, the term “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An acoustic element comprising:
a first enclosure provided with a first enclosure first mouth surrounded by a first enclosure first edge at a first enclosure front longitudinal end; and
a second enclosure at a second enclosure front longitudinal end, with a second enclosure first mouth surrounded by a second enclosure first edge, the second enclosure being arranged inside the first enclosure, the first and second enclosures being joined together at their respective first edges;
a slotting assembly system comprising at least one protruding element arranged on one of the first and second enclosures first edges and at least one recess in another of the first edges of the first and second enclosures, the protruding element and the recess having complementary shapes such that the protruding element can be slotted into the recess.

2. The acoustic element according to claim 1, wherein the assembly system comprises a plurality of protruding element and cooperating recess pairs, and in that, for each of the pairs, the protruding element and the recess have complementary shapes.

3. The acoustic element according to claim 1, wherein the protruding element is a ring and the recess is an annular groove.

4. The acoustic element according to claim 1, wherein the second enclosure comprises, at the first edge, an external lip with a contact face that comes into contact with a front face of the first enclosure first edge when the first and second enclosures are assembled.

5. An acoustic panel for an aircraft, the acoustic panel comprising a plate made of a sound absorbing material and a resistive skin and a rear skin, which are arranged, respectively, on either side of this plate, wherein the plate comprises a plurality of through-housings in the sound absorbing material of the plate, and the acoustic panel comprises a plurality of acoustic elements according to claim 1, each of the acoustic elements being fixed in one of the housings.

6. A propulsion assembly for an aircraft, comprising at least one acoustic panel according to claim 5.

7. An aircraft comprising at least one acoustic panel according to claim 5.
